(19) United States
(12) Patent Application Publication
(10) Pub. No.: US 2026/0189360 A1
(43) Pub. Date: Jul. 2, 2026

(54) SIDE CHANNEL ATTACK PREVENTING APPARATUS, METHOD AND ELECTRONIC APPARATUS USING THE SAME

(71) Applicant: NUVOTON TECHNOLOGY CORPORATION, HSINCHU CITY (TW)

(72) Inventor: Hen Kai CHANG, zhubei City (TW)

(21) Appl. No.: 19/431,525

(22) Filed: Dec. 23, 2025

(30) Foreign Application Priority Data
Dec. 30, 2024 (TW) 113151413

(51) Int. Cl. H04L 9/00; G06F 21/75; G06F 21/81

(52) U.S. Cl. CPC H04L 9/003; G06F 21/755; G06F 21/81

(57) ABSTRACT

A side channel attack prevention apparatus includes a controller and a machine learning module. When a sensitive data processing device and/or an encryption and decryption device of the electronic device is operating, the controller uses a power waveform adjustment manner to change a power waveform of the electronic device. The machine learning module acquires the power waveform during operation of the encryption and decryption device and/or the sensitive data processing device of the electronic device and determines a confidence that the power waveform has a specific characteristic. The power waveform adjustment manner is one selected by the controller from power waveform adjustment manners that have not been selected previously among a plurality of power waveform adjustment manners, and, when the confidence is greater than or equal to a threshold value, the controller reselects one power waveform adjustment manner from the power waveform adjustment manners that have not been selected previously.

### CROSS-REFERENCE TO RELATED APPLICATION

This application claims priority to Taiwanese Patent Application No. 113151413, filed on Dec. 30, 2024. The entire contents of the application are incorporated herein by reference.

### BACKGROUND

### Technical Field

The present invention relates to a side channel attack prevention technology that prevents hackers from performing power analysis to conduct a side channel attack. More particularly, the present invention pertains to a side channel attack prevention apparatus, method, and an electronic device using the same, in which a machine learning model is used to determine whether power waveforms of the electronic device may have a specific characteristic when the electronic device performs encryption and decryption or sensitive data processing.

### Description of Related Art

In order to enhance security of data storage inside a chip (namely, to encrypt data) or to securely exchange data with external entities, it is common for a chip to implement certain encryption algorithms. A typical example is the Advanced Encryption Standard (AES). Since these algorithms have existed for many years, they have been extensively studied by various parties, such as academic researchers and hackers. For AES, power consumption characteristics manifested during its operations have already been well understood. Therefore, a malicious party (for example, a hacker) may infer key used by AES through collecting a large amount of such power consumption characteristics and thereby achieve a purpose of stealing sensitive data. This type of attack is collectively referred to as a side channel attack.

A side channel attack succeeds because encryption algorithms have fixed operations, and the power consumption produced by each operation within the encryption algorithms tends to exhibit certain specific characteristics. As a result, when sufficient data is collected, the key can potentially be deciphered. To counter side channel attacks, some approaches have been proposed, such as adding unnecessary operations (dummy operations) to original AES computation, or repeatedly performing the original computations, so as to confuse the power consumption characteristics and hinder analysis of hackers. Although such approaches may achieve the purpose of disturbing the analysis, the additional hardware required for these methods incurs extra hardware costs. Moreover, the added hardware is fixed, the resulting additional power consumption is also fixed, so the interference it produces is likewise fixed. Therefore, with the continuous advancement of analytical tools, it is necessary to reconsider whether the conventional approaches will remain effective in protecting keys in the future.

### SUMMARY

From the above description, it can be understood that an objective of the present invention is to provide a side channel attack prevention apparatus, method, an electronic device using the same, and a testing device using the same, which make it difficult for a malicious party to determine whether an encryption and decryption device and/or a sensitive data processing device is operating by collecting a large amount of power consumption characteristics.

According to one of the objectives of the present invention, an embodiment provides a side channel attack prevention apparatus. The side channel attack prevention apparatus is disposed in an electronic device or a testing device and includes a controller and a machine learning module. When a sensitive data processing device and/or an encryption and decryption device of the electronic device is operating, the controller uses a power waveform adjustment manner to change a power waveform of the electronic device. The machine learning module is electrically connected to the controller and acquires the power waveform when the encryption and decryption device and/or the sensitive data processing device of the electronic device is operating. The machine learning module uses a trained machine learning model to determine a confidence that the power waveform has a specific characteristic. The power waveform adjustment manner is set by a user. When the confidence is greater than or equal to a threshold value, the controller prompts the user to reset the power waveform adjustment manner. Alternatively, the power waveform adjustment manner is one selected by the controller from previously unselected ones among a plurality of power waveform adjustment manners, and when the confidence is greater than or equal to the threshold value, the controller reselects one from the previously unselected ones among the plurality of power waveform adjustment manners.

According to another objective of the present invention, an embodiment provides an electronic device. The electronic device includes an encryption and decryption device and/or a sensitive data processing device, a plurality of hardware devices, a power conversion device, a controller, and a machine learning module. The power conversion device is electrically connected to the encryption and decryption device and/or the sensitive data processing device and the plurality of hardware devices, receives a power signal, and converts the power signal to generate a supply voltage or a supply current. The controller is electrically connected to the power conversion device, the encryption and decryption device and/or the sensitive data processing device, and the plurality of hardware devices. When the sensitive data processing device and/or the encryption and decryption device is operating, the controller uses a power waveform adjustment manner to change a power waveform corresponding to the power signal. The machine learning module is electrically connected to the controller and the power conversion device. When the encryption and decryption device and/or the sensitive data processing device of the electronic device is operating, the machine learning module acquires the power waveform and uses a trained machine learning model to determine a confidence that the power waveform has a specific characteristic. The power waveform adjustment manner is set by a user. When the confidence is greater than or equal to a threshold value, the controller prompts the user to reset the power waveform adjustment manner. Alternatively, the power waveform adjustment manner is one selected by the controller from previously unselected ones among a plurality of power waveform adjustment manners, and when the confidence is greater than or equal to the threshold value, the controller reselects one from the previously unselected ones among the plurality of power waveform adjustment manners. The power waveform adjustment manner is operated to turn on or turn off at least one of the plurality of hardware devices at different times when the sensitive data processing device or the encryption and decryption device is operating, or to adjust an operating voltage, an operating current, or an operating frequency of at least one of the plurality of hardware devices at different times when the sensitive data processing device or the encryption and decryption device is operating.

According to another objective of the present invention, an embodiment provides a side channel attack prevention method performed in an electronic device or a testing device. The method includes steps of using a power waveform adjustment manner by a controller to change a power waveform of the electronic device when a sensitive data processing device and/or an encryption and decryption device of the electronic device is operating; acquiring the power waveform by a machine learning module when the encryption and decryption device and/or the sensitive data processing device of the electronic device is operating; determining a confidence that the power waveform has a specific characteristic by using a trained machine learning model; setting the power waveform adjustment manner by a user and prompting the user by the controller to reset the power waveform adjustment manner when the confidence is greater than or equal to a threshold value; or selecting the power waveform adjustment manner by the controller from previously unselected ones among a plurality of power waveform adjustment manners and reselecting another of the previously unselected power waveform adjustment manners when the confidence is greater than or equal to the threshold value by the controller.

As described above, compared with the prior art, the side channel attack prevention apparatus, the side channel attack prevention method, and the electronic device using the same provided by the present invention can ensure that a malicious party cannot easily determine whether an encryption and decryption device and/or a sensitive data processing device is operating by collecting a large amount of power consumption characteristics. As a result, the security of the electronic device is improved, and the theft or destruction of keys or sensitive data can be avoided. In addition, apart from adding a machine learning module, the electronic device provided in the present invention does not require additional hardware devices. Therefore, compared with the prior art, hardware installation costs can be reduced, and unnecessary power consumption may also be effectively reduced.

### BRIEF DESCRIPTION OF THE DRAWINGS

FIG. 1 is a block diagram of an electronic device having a side channel attack prevention apparatus according to an embodiment of the present invention.

FIG. 2 is an original power waveform of the electronic device when an encryption and decryption device and/or a sensitive data processing device of the electronic device is operating according to an embodiment of the present invention.

FIG. 3 is an adjusted power waveform of the electronic device when the encryption and decryption device and/or the sensitive data processing device of the electronic device is operating according to an embodiment of the present invention.

FIG. 4 is a flowchart of a side channel attack prevention method according to an embodiment of the present invention.

### DETAILED DESCRIPTION

The primary objective of the present invention is to provide a side channel attack prevention apparatus, a side channel attack prevention method, and an electronic device using the same, which can prevent malicious parties from determining whether an encryption and decryption device and/or a sensitive data processing device is operating by collecting a large amount of power consumption characteristics. To achieve this objective, the side channel attack prevention apparatus, the side channel attack prevention method, and the electronic device using the same provided by the present invention determine a confidence that a power waveform of the electronic device has a specific characteristic when the sensitive data processing device and/or the encryption and decryption device is operating by using a machine learning model, either before the electronic device leaves the factory or in a secure environment (for example, a non-networked environment or another environment in which malicious parties cannot acquire the power waveform).

When a confidence is greater than or equal to a threshold value, another power waveform adjustment manner is applied during the operation of a sensitive data processing device and/or an encryption and decryption device so as to change the confidence that a power waveform has a specific characteristic until the confidence is less than the threshold value. When the confidence that the power waveform of the electronic device has a specific characteristic during the operation of the sensitive data processing device and/or the encryption and decryption device is less than the threshold value, this indicates that a malicious party cannot easily determine whether the encryption and decryption device and/or the sensitive data processing device is operating by collecting a large amount of power consumption characteristics.

The following description uses the drawings to explain possible embodiments of the present invention in detail. However, it should be noted that the implementation details described below are not intended to limit the scope of the claims of the present invention, but are provided merely to facilitate understanding by those of ordinary skill in the art.

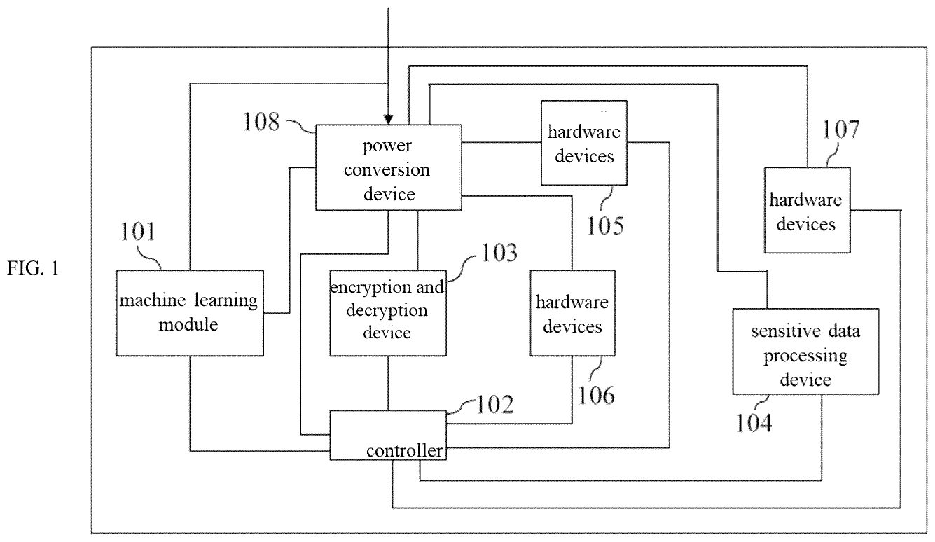

First, please refer to FIG. 1. FIG. 1 is a block diagram of an electronic device having a side channel attack prevention apparatus according to an embodiment of the present invention. The electronic device includes an encryption and decryption device 103 and/or a sensitive data processing device 104, a plurality of hardware devices 105 to 107, a power conversion device 108, a controller 102, and a machine learning module 101. The power conversion device 108 is electrically connected to the encryption and decryption device 103 and/or the sensitive data processing device 104, the plurality of hardware devices 105 to 107, the controller 102, and the machine learning module 101. The controller 102 is electrically connected to the encryption and decryption device 103 and/or the sensitive data processing device 104, the plurality of hardware devices 105 to 107, and the machine learning module 101.

The side channel attack prevention apparatus of the present invention mainly includes a controller 102 and a machine learning module 101. The controller 102 is used to change a power waveform of the electronic device by using a power waveform adjustment manner when a sensitive data processing device 104 and/or an encryption and decryption device 103 of the electronic device is operating. The machine learning module 101 is electrically connected to the controller 102 and is used to acquire the power waveform when the sensitive data processing device 104 and/or the encryption and decryption device 103 of the electronic device is operating and to determine a confidence that the power waveform has a specific characteristic by using a trained machine learning model. Furthermore, the machine learning model may be at least one of a Support Vector Machine (SVM), a forward neural network, a Recurrent Neural Network (RNN), a Convolution Neural Network (CNN), a Gated Recurrent Unit (GRU), and a Long-Short Term Memory (LSTM) network.

In one embodiment, a power waveform adjustment manner is set by a user, for example, by issuing a command to the controller 102 to set the power waveform adjustment manner manually. In this case, when a confidence is greater than or equal to a threshold value, the controller 102 prompts the user to reset the power waveform adjustment manner, for example, by outputting a result indicating that the confidence is greater than or equal to the threshold value to inform the user of the result. When the sensitive data processing device 104 and/or the encryption and decryption device 103 subsequently operates after the power waveform adjustment manner is reset, the machine learning module 101 determines a confidence that the power waveform has a specific characteristic again by using a machine learning model. When the confidence is less than the threshold value, the controller 102 prompts the user that the currently set power waveform adjustment manner can be applied during subsequent operation of the sensitive data processing device 104 and/or the encryption and decryption device 103.

In another embodiment, the controller 102 selects one power waveform adjustment manner from the previously unselected power waveform adjustment manners of a plurality of power waveform adjustment manners, that is, the power waveform adjustment manner is selected automatically. In this case, when a confidence is greater than or equal to a threshold value, the controller 102 reselects one power waveform adjustment manner from the power waveform adjustment manners that have not been selected previously. When the confidence is less than the threshold value, the controller 102 records the selected power waveform adjustment manner, for example, by writing the power waveform adjustment manner into a non-volatile memory, and, during subsequent operation of the sensitive data processing device 104 and/or the encryption and decryption device 103, the controller 102 reads the recorded power waveform adjustment manner from the non-volatile memory and uses the recorded power waveform adjustment manner to change a power waveform.

The power conversion device 108 is used to receive a power signal and convert the power signal to generate a supply voltage or a supply current for the encryption and decryption device 103 and/or the sensitive data processing device 104, the plurality of hardware devices 105 to 107, the controller 102, and the machine learning module 101. A power waveform corresponding to the power signal may be a voltage waveform, a current waveform, or a power consumption waveform. In addition, a specific characteristic of the power waveform may be a time-domain characteristic and/or a frequency-domain characteristic of the power waveform.

The encryption and decryption device 103 may be, but is not limited to, an AES encryption and decryption device, and the encryption and decryption device 103 may also be an RSA encryption and decryption device or another encryption and decryption device whose operation may be identified through a side channel attack. In short, the present invention is not limited by the type of the encryption and decryption device 103. The sensitive data processing device 104 may be another encryption and decryption device, an encrypted data storage device, or another device that processes sensitive data, and, when the sensitive data processing device 104 processes the sensitive data, it may also cause a power waveform corresponding to a power signal of the electronic device to have a specific characteristic.

To make it difficult to observe that a power waveform has a specific characteristic during the operation of the encryption and decryption device 103 and/or the sensitive data processing device 104, the controller 102 controls at least one of the plurality of hardware devices 105 to 107 to turn on or turn off at different times during the operation of the sensitive data processing device 104 or the encryption and decryption device 103 according to a power waveform adjustment manner set by a user or selected by the controller 102. Alternatively, the controller 102 controls at least one of the plurality of hardware devices 105 to 107 at different times during the operation of the sensitive data processing device 104 or the encryption and decryption device 103 to adjust an operating voltage, an operating current, or an operating frequency of the at least one hardware device.

Once a confidence that a power waveform has a specific characteristic is found to be less than a threshold value, the corresponding power waveform adjustment manner can be applied during subsequent operation of the encryption and decryption device 103 and/or the sensitive data processing device 104 so as to achieve the purpose of preventing a side channel attack. In addition, the hardware devices 105 to 107 are not hardware devices additionally added to the electronic device but are hardware devices originally included in the electronic device, and therefore, unlike the prior art that requires additional hardware devices, the technical solution of the present invention can effectively reduce hardware setup costs.

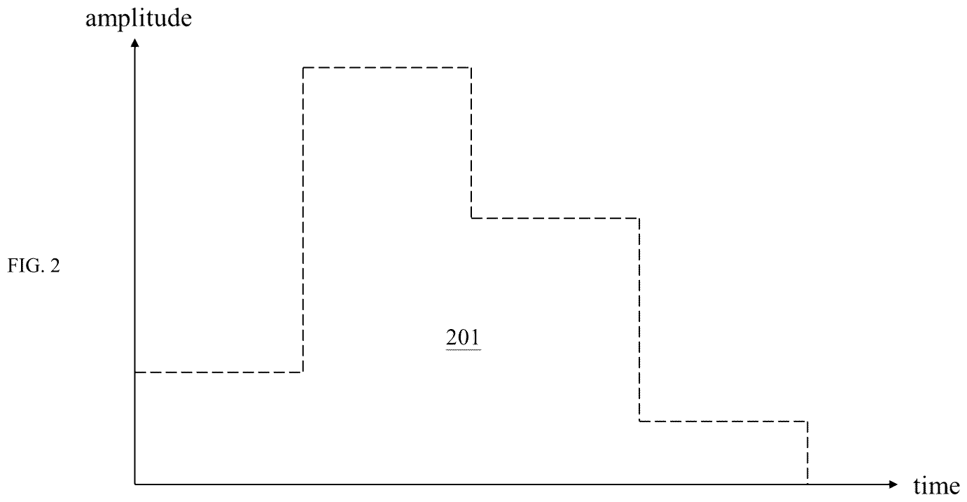

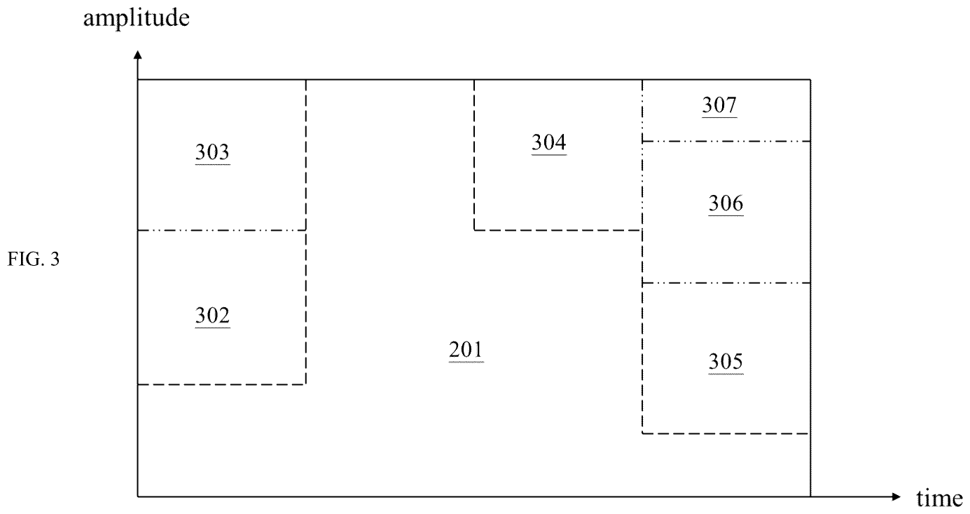

Please refer to FIGS. 1 to 3. FIG. 2 shows an original power waveform of the electronic device when the encryption and decryption device 103 and/or the sensitive data processing device 104 of the electronic device is operating, and FIG. 3 shows an adjusted power waveform of the electronic device when the encryption and decryption device 103 and/or the sensitive data processing device 104 of the electronic device is operating according to an embodiment of the present invention. In FIG. 2, the original power waveform 201 of the electronic device when the encryption and decryption device 103 and/or the sensitive data processing device 104 is operating has a specific characteristic and can therefore be easily analyzed by a malicious party to determine that the encryption and decryption device 103 and/or the sensitive data processing device 104 is operating. After a power waveform adjustment manner found by using the machine learning model is applied, the power waveform of the electronic device when the encryption and decryption device 103 and/or the sensitive data processing device 104 is operating becomes a combination of the power waveform 201 and the power waveforms 302 to 307, as shown in FIG. 3. Among these power waveforms, the power waveforms 302, 304, and 305 are generated when the hardware device 105 is turned on; the power waveforms 302 and 306 are generated when the hardware device 106 is turned on; and the power waveform 307 is generated when the hardware device 107 is turned on.

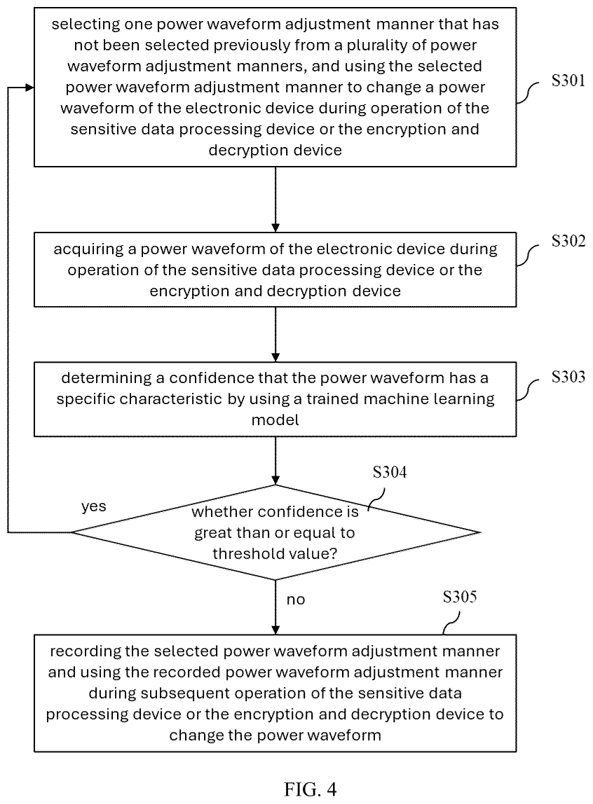

Please refer to FIGS. 1 and 4. FIG. 4 is a flowchart of a side channel attack prevention method according to an embodiment of the present invention. Step S301: the controller 102 selects one previously unselected power waveform adjustment manner from a plurality of power waveform adjustment manners and uses the selected power waveform adjustment manner to change a power waveform of the electronic device during operation of the sensitive data processing device 104 or the encryption and decryption device 103. Step S302: the machine learning module 101 acquires a power waveform of the electronic device during operation of the sensitive data processing device 104 or the encryption and decryption device 103. Step S303: the machine learning module 101 determines a confidence that the power waveform has a specific characteristic by using a trained machine learning model. Step S304: the controller 102 determines whether the confidence is greater than or equal to a threshold value. When the confidence is greater than or equal to the threshold value, Step S301 is executed again to reselect one previously unselected power waveform adjustment manner from the plurality of power waveform adjustment manners; when the confidence is less than the threshold value, Step S305 is executed. Step S305: the controller 102 records the selected power waveform adjustment manner and, during subsequent operation of the sensitive data processing device 104 or the encryption and decryption device 103, uses the recorded power waveform adjustment manner to change the power waveform.

It should be noted that the side channel attack prevention method shown in FIG. 4 is described by way of example in a case where the controller 102 automatically selects a power waveform adjustment manner; however, as described above, in one embodiment, the power waveform adjustment manner may also be set manually. In the case of manually setting the power waveform adjustment manner, Step S301 becomes using the set power waveform adjustment manner during operation of the sensitive data processing device 104 or the encryption and decryption device 103 to change a power waveform of the electronic device, and Step S305 becomes prompting a user that the currently set power waveform adjustment manner can be applied during subsequent operation of the sensitive data processing device 104 and/or the encryption and decryption device 103.

It should be noted that, in the above embodiments, the controller 102 and the machine learning module 101 are disposed in the electronic device, but the present invention is not limited thereto. In other embodiments, the controller 102 and the machine learning module 101 are disposed in a testing device, and the electronic device includes another controller electrically connected to the controller 102, the encryption and decryption device 103 and/or the sensitive data processing device 104, and the plurality of hardware devices 105 to 107. The controller 102 of the testing device is used to communicate with the controller of the electronic device, and the testing device can find an appropriate power waveform adjustment manner for the electronic device during a testing stage, so that when the encryption and decryption device 103 and/or the sensitive data processing device 104 of the electronic device is operating, the controller of the electronic device can use the appropriate power waveform adjustment manner found by the controller 102 of the testing device to prevent a side channel attack.

In summary, the side channel attack prevention apparatus, the side channel attack prevention method, and the electronic device using the same provided by the present invention have the following features. First, a machine learning model is used to determine whether a specific characteristic of a power waveform of an electronic device is apparent. An apparent characteristic indicates that a key or sensitive data of the electronic device can be easily obtained after a side channel attack, and when a selected power waveform adjustment manner can make the machine learning model determine that the specific characteristic of the power waveform is not apparent, it indicates that the key or sensitive data is difficult to obtain even under a side channel attack. Secondly, the machine learning model can be updated so that its determination capability keeps pace with new developments. Thirdly, the prior art generates masking effects by adding extra hardware devices, but the masking capability is fixed and therefore lacks flexibility. In contrast, the technical solution of the present invention that uses a machine learning model is more flexible and more capable of addressing unknown attack types. Fourthly, although the electronic device of the present invention may also include additional hardware devices and may turn on such hardware devices to mask a power waveform when necessary, it is preferable not to add extra hardware devices and instead to turn on hardware devices originally included in the electronic device to reduce hardware cost. Fifthly, in the present invention, the power waveform adjustment manner for turning on hardware devices to mask a power waveform may be set manually, selected by the controller, or even selected automatically by introducing another machine learning model.

The present invention has been disclosed herein by way of exemplary embodiments. However, it will be understood by those skilled in the art that these embodiments are provided for illustrative purposes only and are not intended to limit the scope of the claimed invention. Any modifications or substitutions that are equivalent or have a substantially equivalent effect to the embodiments described above should be interpreted as falling within the spirit or scope of the present invention. Accordingly, the scope of protection for the present invention shall be defined by the following claims.

What is claimed is:

1. A side channel attack prevention apparatus, disposed in an electronic device or a testing device, and comprising:
a controller configured to use a power waveform adjustment manner to change a power waveform of the electronic device during an operation of a sensitive data processing device and/or an encryption and decryption device of the electronic device; and
a machine learning module electrically connected to the controller and configured to acquire the power waveform during an operation of the encryption and decryption device and/or the sensitive data processing device of the electronic device and to determine a confidence that the power waveform has a specific characteristic by using a trained machine learning model;
wherein the power waveform adjustment manner is set by a user and the controller prompts the user to reset the power waveform adjustment manner when the confidence is greater than or equal to a threshold value, or the power waveform adjustment manner is one selected by the controller from power waveform adjustment manners that have not been selected previously among a plurality of power waveform adjustment manners and the controller reselects another of the power waveform adjustment manners that have not been selected previously when the confidence is greater than or equal to the threshold value.

2. The side channel attack prevention apparatus of claim 1, wherein the power waveform adjustment manner is one selected by the controller from power waveform adjustment manners that have not been selected previously among the plurality of power waveform adjustment manners, and
the controller records the selected power waveform adjustment manner when the confidence is less than the threshold value and causes the electronic device to use the recorded power waveform adjustment manner during subsequent operation of the sensitive data processing device and/or the encryption and decryption device to change the power waveform.

3. The side channel attack prevention apparatus of claim 1, wherein the power waveform adjustment manner is operated to turn on or turn off at least one hardware device of the electronic device at different times during the operation of the sensitive data processing device or the encryption and decryption device, or adjust an operating voltage, an operating current, or an operating frequency of the at least one hardware device of the electronic device at different times during the operation of the sensitive data processing device or the encryption and decryption device.

4. The side channel attack prevention apparatus of claim 1, wherein the power waveform is a voltage waveform, a current waveform, or a power consumption waveform, and the specific characteristic is a time-domain characteristic and/or a frequency-domain characteristic of the power waveform.

5. The side channel attack prevention apparatus of claim 1, wherein the electronic device comprises the machine learning module and the controller, or the electronic device does not comprise the machine learning module and the controller and the machine learning module and the controller are disposed in the testing device outside the electronic device.

6. An electronic device, comprising:
an encryption and decryption device and/or a sensitive data processing device;
a plurality of hardware devices;
a power conversion device electrically connected to the encryption and decryption device and/or the sensitive data processing device and to the plurality of hardware devices, wherein the power conversion device is configured to receive a power signal and convert the power signal to generate a supply voltage or a supply current;
a controller electrically connected to the power conversion device, the encryption and decryption device and/or the sensitive data processing device, and the plurality of hardware devices, wherein the controller is configured to use a power waveform adjustment manner to change a power waveform corresponding to the power signal of the electronic device during operation of the sensitive data processing device and/or the encryption and decryption device; and
a machine learning module electrically connected to the controller and the power conversion device, wherein the machine learning module is configured to acquire the power waveform during an operation of the encryption and decryption device and/or the sensitive data processing device of the electronic device and determine a confidence that the power waveform has a specific characteristic by using a trained machine learning model;
wherein the power waveform adjustment manner is set by a user and the controller prompts the user to reset the power waveform adjustment manner when the confidence is greater than or equal to a threshold value, or the power waveform adjustment manner is one selected by the controller from power waveform adjustment manners that have not been selected previously among a plurality of power waveform adjustment manners and the controller reselects another of the power waveform adjustment manners that have not been selected previously when the confidence is greater than or equal to the threshold value; and
wherein the power waveform adjustment manner is operated to turn on or turn off at least one of the plurality of hardware devices of the electronic device at different times during the operation of the sensitive data processing device or the encryption and decryption device, or adjust an operating voltage, an operating current, or an operating frequency of the at least one hardware device of the electronic device at different times during the operation of the sensitive data processing device or the encryption and decryption device.

7. The electronic device of claim 6, wherein the machine learning model is at least one of a support vector machine, a forward neural network, a recurrent neural network, a convolution neural network, a gated recurrent unit, and a long-short term memory network.

8. The electronic device of claim 6, wherein the power waveform adjustment manner is one selected by the controller from power waveform adjustment manners that have not been selected previously among the plurality of power waveform adjustment manners, and the recorded power waveform adjustment manner is written into a non-volatile memory by the controller.

9. A side channel attack prevention method executed in an electronic device or a testing device, comprising:
using a power waveform adjustment manner to change a power waveform of the electronic device during an operation of a sensitive data processing device and/or an encryption and decryption device of the electronic device by a controller;
acquiring the power waveform by a machine learning module during an operation of the encryption and decryption device and/or the sensitive data processing device of the electronic device and determining a confidence that the power waveform has a specific characteristic by using a trained machine learning model; and
setting the power waveform adjustment manner by a user and prompting the user to reset the power waveform adjustment manner by the controller when the confidence is greater than or equal to a threshold value, or selecting the power waveform adjustment manner by the controller as one selected from power waveform adjustment manners that have not been selected previously among a plurality of power waveform adjustment manners and reselecting another of the power waveform adjustment manners that have not been selected previously by the controller when the confidence is greater than or equal to the threshold value.

10. The side channel attack prevention method of claim 9, wherein the power waveform adjustment manner is one selected by the controller from power waveform adjustment manners that have not been selected previously among the plurality of power waveform adjustment manners, and the recorded power waveform adjustment manner is written into a non-volatile memory by the controller.
